(19) United States
(12) Patent Application Publication
(10) Pub. No.: US 2006/0034640 A1
(43) Pub. Date: Feb. 16, 2006

(54) Wet-type electrophotographic image forming apparatus

(75) Inventors: Myoung-chan Kim, Seoul (KR); Seung-yoon Lee, Suwon-si (KR); Woong-jae Chang, Seongnam-si (KR); Jeong-seop Hong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/199,284

(22) Filed: Aug. 9, 2005

(30) Foreign Application Priority Data
Aug. 14, 2004 (KR) 2004-64112

(51) Int. Cl. G03G 15/10

(52) U.S. Cl. 399/238

(57) ABSTRACT

A wet-type image forming apparatus includes a body having an openable door. A developing unit is installed in the body and develops an image on a photosensitive body. An ink cartridge is detachable with respect to the body and stores ink therein. A fitting unit is installed between the developing unit and the ink cartridge. The fitting unit moves up and down to couple the developing unit to the ink cartridge to withdraw the ink from the developing unit.

### CROSS-REFERENCE TO RELATED APPLICATIONS

This application claims the benefit under 35 U.S.C. § 119(a) of Korean Patent Application No. 2004-641 f2 filed Aug. 14, 2004, in the Korean Intellectual Property Office, the entire disclosure of which is hereby incorporated by reference.

### BACKGROUND OF THE INVENTION

1. Field of the Invention

The present invention relates to a wet-type image forming apparatus using a liquid developer. More particularly, the present invention relates to a wet-type electrophotographic image forming apparatus including an ink cartridge for feeding ink to or withdrawing ink from a developing unit and a fitting unit.

2. Description of the Related Art

Generally, image forming apparatuses can be classified into dry-type image forming apparatuses using a powdered dry developer and wet-type image forming apparatuses using a liquid wet developer. The dry-type and wet-type image forming apparatuses each provide certain advantages. However, the wet-type image forming apparatuses can obtain a clearer, higher resolution printed material than the dry-type image forming apparatuses. Particularly, with the increasing popularization of digital cameras, a clear, high-quality printed material having natural color is required. Thus, the demand for color image forming apparatuses has been gradually increased.

However, in such a wet-type image forming apparatus, a much larger amount of developer than an amount of developer necessary for substantial printing should be fed to a developing unit performing a developing process to obtain satisfactory printing quality. Thus, developer that is not being used in printing is withdrawn to an ink cartridge.

FIG. 1 is a schematic view of a conventional wet-type electrophotographic image forming apparatus performing such an ink withdrawing process. As shown in FIG. 1, the wet-type electrophotographic image forming apparatus includes developing units 16 including photosensitive bodies 12, ink cartridges 15 feeding ink to the developing units 16 and withdrawing the ink from the developing units 16, and fitting units 20 coupling the developing units 16 and the ink cartridges 15.

A reference numeral 18 denotes an intermediate transfer belt to which images formed on the photosensitive bodies 12 are transferred to be overlapped. Reference numeral 17 denotes transfer backup rollers transferring the images from the photosensitive bodies 12 to the intermediate transfer belt 18. A reference character P denotes a paper transferring path.

The fitting units 20 include coupling tubes 25 forming flowing paths for the ink, nut and bolt fitting portions 21 and 22 coupling the developing units 16 and the coupling tubes 25, nut and bolt fitting portions 23 and 24 coupling the ink cartridges 15 and the coupling tubes 25, and withdrawing pumps 26.

A process of circulating the ink in the wet-type electrophotographic image forming apparatus having the above-described structure will now be described. After the ink cartridges 15 and the developing units 16 are mounted in the wet-type electrophotographic image forming apparatus, the nut and bolt fitting portions 21, 22, 23, and 24 are combined between the ink cartridges 15 and the fitting units 20 and between the developing units 16 and the fitting units 20. Thereafter, when a printing command is requested, the ink is fed from the ink cartridges 15 to the developing units 16 through feeding pumps (not shown). After a predetermined developing process is performed, the ink may not be used for a printing operation and remains in the developing units 16. The remaining ink is withdrawn to the ink cartridges 15 through the withdrawing pumps 26 and the coupling tubes 25.

Coupling apparatuses are necessarily required between the developing units 16 and the ink cartridges 15 to circulate wet ink. Also, the airtightness of the coupling apparatuses is very important in terms of the characteristics of the wet ink. In the above-described coupling and airtightness methods, the coupling apparatuses, such as the bolt fitting portions 22 and 24 and the nut fitting portions 21 and 23 including O-rings and springs, are generally used with the developing units 16 and the ink cartridges 15.

However, the above-mentioned coupling apparatuses include additional power sources such as pumps and nut and bolt fitting portions. Thus, the structure of the coupling apparatuses is complicated and manufacturing costs for the coupling apparatuses is increased. Moreover, the nut and bolt fitting portion 23 and 24 should be manually combined to connect the fitting units 20 and the ink cartridges 15.

Furthermore, during the ink withdrawing process, the flowing paths for the ink between the fitting units 20 and the ink cartridges 15 may be curved, and the area of the flowing paths may be suddenly reduced. Thus, the ink may stick to the flowing paths. As a result, the flowing paths may be clogged or a function of combining or opening and closing the fitting units 20 may be deteriorated. Particularly, this may frequently occur in places where the nut fitting portions 21 and 22 and the bolt fitting portions 23 and 24 are combined or in places where the bolt fitting portions 22 and 24 are coupled to the coupling tubes 25. When the nut and bolt fitting portions 21, 22, 23, and 24 or the coupling tubes 25 are clogged, the ink may be continuously fed to the developing units 16 but not withdrawn from the developing units 16. Thus, the ink may overflow in the developing units 16. The overflowing ink may contaminate various components of the wet-type electrophotographic image forming apparatus. As a result, the wet-type electrophotographic image forming apparatus may not operate. Also, the ink may flow outside the wet-type electrophotographic image forming apparatus. Thus, the surroundings may be seriously contaminated.

Accordingly, a need exists for an improved wet-type electrographic image forming apparatus in which withdrawn ink does not clog a drainpipe or contaminate surrounding apparatus.

### SUMMARY OF THE INVENTION

Accordingly, an aspect of the present invention is to provide a wet-type electrophotographic image forming apparatus including a simply structured fitting unit capable of not changing a path of ink flow during an ink withdrawing process.

According to another aspect of the present invention, a wet-type electrophotographic image forming apparatus including a body having an openable door, a developing unit installed in the body and developing an image on a photosensitive body, an ink cartridge detachable with respect to the body and that stores ink therein, and a fitting unit installed between the developing unit and the ink cartridge. The fitting unit moves up and down to couple the developing unit to the ink cartridge to withdraw the ink from the developing unit.

The fitting unit may move in association with opening and closing of the door. Therefore, the fitting unit descends to thereby fluidly connect the developing unit and the ink cartridge. When the door is opened, the fitting unit ascends to thereby separate the developing unit from the ink cartridge.

The fitting unit may include a drainpipe that forms an ink flowing path and that ascends and descends in a substantially vertical direction to couple the developing unit to and separate the developing unit from the ink cartridge. A drainpipe transferring unit moves in association with the door so as to move the drainpipe.

The drainpipe transferring unit may include a coupling member that moves substantially horizontally, and a wire that substantially vertically moves the drainpipe with the horizontal movement of the coupling member. The drainpipe transferring unit may further include a flexible film having a first end fixed to the drainpipe and a second end fixed to the holder to substantially prevent the ink inside the developing unit from flowing out from the drainpipe and into the drainpipe transferring unit.

The ink cartridge may include a drainpipe inlet into which the drainpipe is inserted. A transferring bar moves with the opening and closing of the door to horizontally move the coupling member.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above aspects and features of the present invention will be more apparent by describing certain embodiments of the present invention with reference to the accompanying drawings, in which:

FIG. 1 is a schematic view of a conventional wet-type electrophotographic image forming apparatus;

FIG. 2 is a schematic view of a wet-type electrophotographic image forming apparatus according to an embodiment of the present invention;

FIG. 3 is a perspective view of an ink cartridge of FIG. 2;

FIG. 4 is an enlarged elevational view of the main components of the ink cartridge of FIG. 2; and

FIG. 5 is an enlarged elevational view of FIG. 4 in which a door is closed.

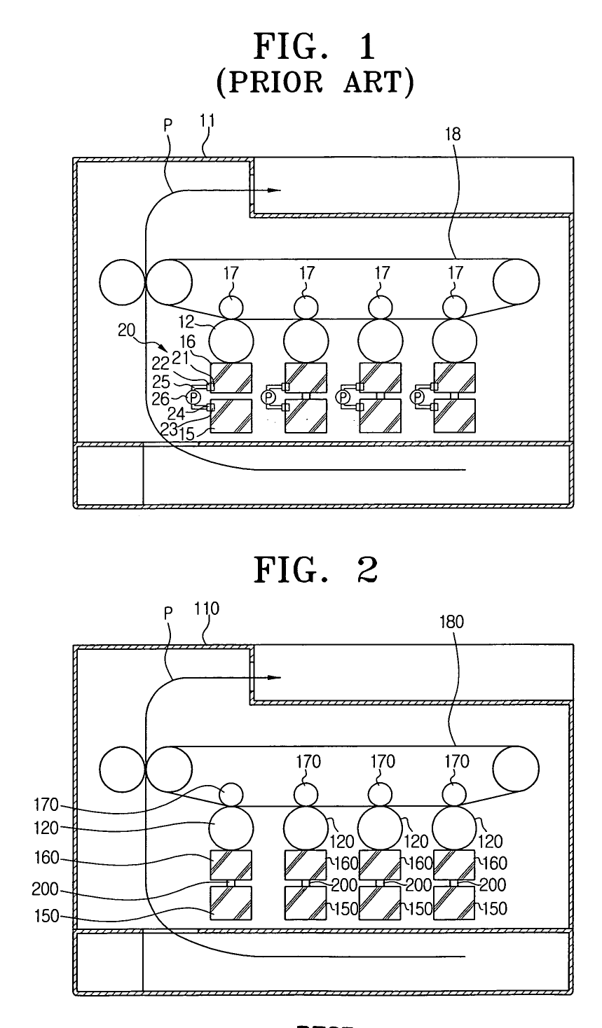

Throughout the drawings, like reference numerals will be understood to refer to like parts, components and structures.

### DETAILED DESCRIPTION OF EXEMPLARY EMBODIMENTS

Certain embodiments of the present invention will be described in greater detail with reference to the accompanying drawings.

The matters defined in the description, such as a detailed construction and elements thereof, are provided to assist in a comprehensive understanding of the invention. Thus, it is apparent that the present invention may be carried out without those defined matters. Also, well-known functions or constructions are not described in detail to provide a clear and concise description.

Hereinafter, a wet-type electrophotographic image forming apparatus according to an embodiment of the present invention is described in detail with reference to the attached drawings.

FIG. 2 is a schematic view of a wet-type electrophotographic image forming apparatus according to an exemplary embodiment of the present invention. Referring to FIG. 2, the wet-type electrophotographic image forming apparatus includes an image forming apparatus body 110, a plurality of developing units 160 supplying ink to photosensitive bodies 120 to form images, ink cartridges 150 storing the ink, and fitting units 200.

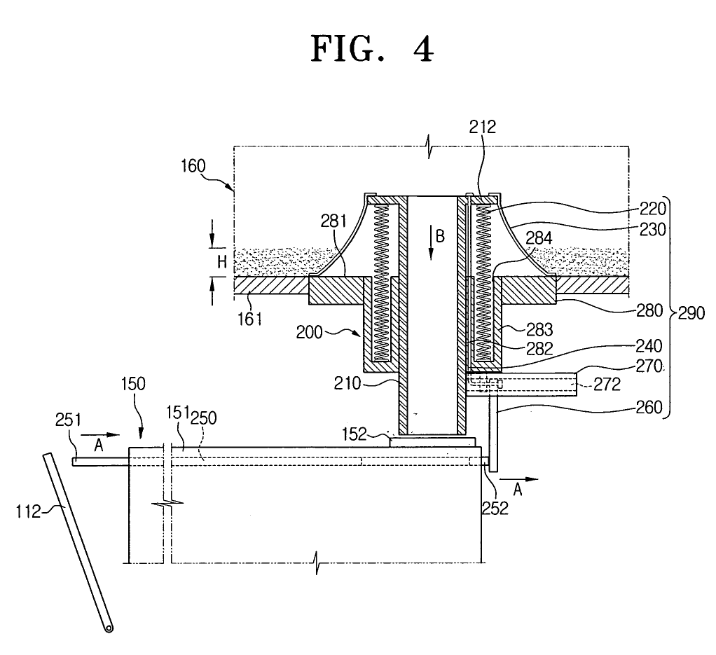

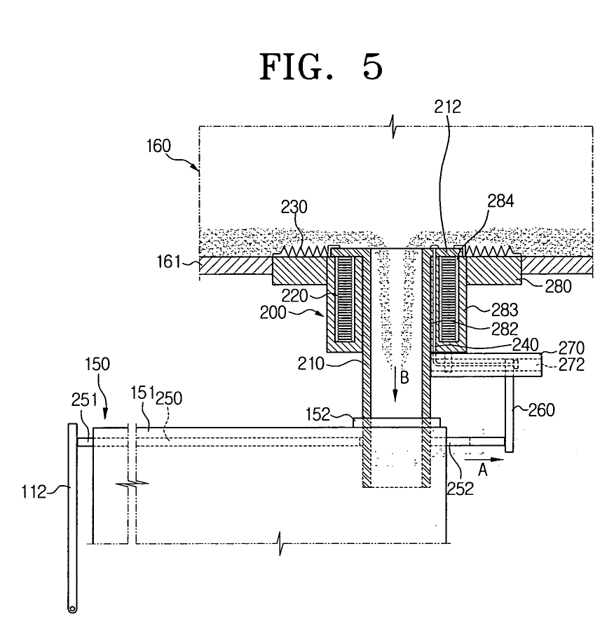

The image forming apparatus body 110 encloses components of the wet-type electrophotographic image forming apparatus, such as the developing units 160, the ink cartridges 150 and the fitting units 200, and includes doors 112 (refer to FIGS. 4 and 5) installed at ends thereof to open and close the ink cartridges.

The developing units 160 are installed above the ink cartridges 150 and transfer the ink to the photosensitive bodies 120 to form the images. The ink fed from the ink cartridges 150 to the developing units 160 form the images on the photosensitive bodies 120, and then the remaining ink is withdrawn to the ink cartridges 150.

A reference numeral 180 denotes an intermediate transfer belt, and reference numeral 170 denotes backup rollers supporting the transfer belt 180 to transfer the images from the photosensitive bodies 120 to the intermediate transfer belt 180. A reference character P denotes a paper transferring path.

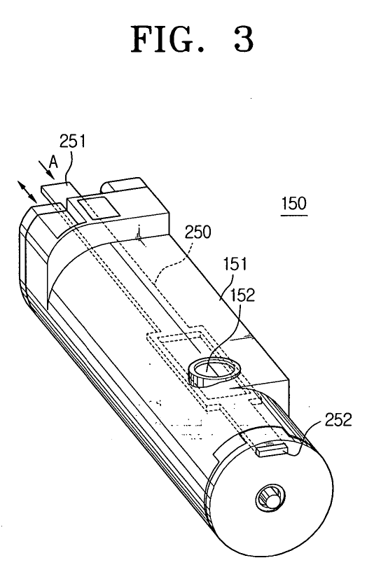

Referring to FIG. 3, the ink cartridge 150 includes a cylinder-shaped housing 151, a drainpipe inlet 152 formed in the housing 151, and a transferring bar 250 installed inside the housing 151 in a horizontal direction (direction ‘A’ indicated by an arrow). The drainpipe inlet 152 is formed in an upper surface of the housing 151, and a drainpipe 210 of the fitting unit 100 is withdrawn from or inserted into the drainpipe inlet 152 as shown in FIGS. 4 and 5. The transferring bar 250 is moveably installed in an inner upper portion of the ink cartridge 150 in the horizontal direction and includes a first end 251 protruding toward the door 112 as shown in FIG. 4 and a second end 252 moving together with a coupling member 260 of the fitting unit 200 that will be described later. Referring to FIG. 2, the ink cartridges 150 respectively store different color inks, such as yellow (Y), magenta (M), cyan (C) and black (B), in spaces enclosed by the housings 151 and supply the different color inks to the developing units 160, respectively.

FIG. 4 is an enlarged elevational view in partial cross section of the coupling of the developing unit 160, the ink cartridge 150, and the fitting unit 200 of FIG. 2. Referring to FIG. 4, the fitting unit 200 includes the drainpipe 210 and a drainpipe transferring unit 290.

The drainpipe 210 includes an upper portion inserted into the developing unit 160 and a lower portion protruding outside the developing unit 160. The drainpipe 210 serves as a flow path of the withdrawn ink and moves downward when the ink cartridge 150 is mounted in the image forming apparatus body 110 and the door 112 is closed so that the lower portion thereof is inserted into the ink cartridge 150 through the drainpipe inlet 152. A supporting portion 212 having a predetermined radius is formed at a top end of the drainpipe 210. Thus, when the drainpipe 210 moves downwardly, the supporting portion 212 is hooked on an upper surface 281 of a holder 280 and thus cannot move to a predetermined depth or more, as shown in FIG. 5. Since the drainpipe 210 vertically moves up and down, the drainpipe 210 may be formed of a material that is not rusted and bent. Also, the drainpipe 210 may be formed so that the inner area thereof is not changed.

The drainpipe transferring unit 290 includes the holder 280, an elastic member 220, a flexible film 230, a wire 240, the coupling member 260, and a guide member 270.

The holder 280 includes an upper portion fixed to a housing 161 of the developing unit 160 and a hole through which the drainpipe 210 penetrates. An elastic member housing hole 284 into which the elastic member 220 is inserted is formed between an inner wall 282 and an outer wall 283 of the holder 280.

The elastic member 220 includes an end fixed to the supporting portion 212 of the drain pipe 210 and the other end penetrating through the elastic member housing hole 284 of the holder 280 so as to be fixed to a lower end of the elastic member housing hole 284. When the ink cartridge 150 is not mounted in the image forming apparatus body 110 (FIG. 2) or when the door 112 is unclosed although the ink cartridge 150 is mounted (FIG. 4), the elastic member 220 keeps a height of the drainpipe 210 inserted into the developing unit 160 to be higher than a head height H of the remaining ink. As a result, the ink remaining in the developing unit 160 cannot flow out from the developing unit 160.

The flexible film 230 includes an end fixed to an end of the supporting portion 212 of the drainpipe 210 and the other end fixed to the upper surface 281 of the holder 280. The flexible film 230 prevents the ink from flowing between the drainpipe 210 and the holder 280. Thus, the drainpipe transferring unit 290 including the elastic member 220, the holder 280, and the like is isolated from the ink and thus may be substantially prevented from malfunctioning due to sticking of the ink thereto. The flexible film 230 moves with the up and down movements of the drainpipe 210 and substantially prevents the ink from flowing in and out. Thus, the flexible layer 230 may be formed of a flexible film.

The wire 240 includes an end fixed to a top end of the supporting portion 212 of the drainpipe 210. The wire 240 penetrates through the supporting portion 212 and the inner wall 282 of the holder 280 so that the other end thereof penetrates through and is fixed to the coupling member 260. The wire 240 moves with the movement of the coupling member 260 in direction ‘A’ indicated by an arrow, and thus the drainpipe 210 vertically descends in direction ‘B’ indicated by an arrow. Thus, the lower portion of the drainpipe 210 is inserted into the ink cartridge 150 through the drainpipe inlet 152. As described above, since the wire 240 pulls the drainpipe 210 due to the movement of the coupling member 260, the wire 240 may be formed of a metallic material that does not lengthen.

The coupling member 260 is installed so that a side of a lower portion thereof contacts the end 252 of the transferring bar 250. The wire 240 is fixed to a side of an upper portion of the coupling member 260. As the transferring bar 250 moves in the direction ‘A’, the coupling member 260 contacting the transferring member 250 also moves in the direction ‘A’. The guide member 270 includes a guide rail 272 housing the upper portion of the coupling member 260 to guide a horizontal movement of the coupling member 260.

The operation of combining the developing unit 160, the fitting unit, 200, and the ink cartridge 150 is described below with reference to FIGS. 2 through 5.

When the developing unit 160 and the ink cartridge 150 are not mounted in the image forming apparatus body 110 or when the door 112 is not closed although the developing unit 160 and the ink cartridge 150 are mounted, as shown in FIG. 4, the drainpipe 210 of the fitting unit 200 is higher than the head height H of the ink inside the developing unit 160 due to an elastic force of the elastic member 220.

When the door 112 is closed, the transferring bar 250 is pushed in the direction ‘A’. Thus, the coupling member 260 contacting the transferring bar 250 is also pushed in the direction ‘A’ as shown in FIG. 4. The wire 240 moves with the movement of the coupling member 260 to pull the drainpipe 210 downwardly in the direction ‘B’. Thus, the drainpipe 210 vertically descends in response to a horizontal movement distance of the transferring bar 250 to be inserted in the ink cartridge 150 through the drainpipe inlet 152. As shown in FIG. 5, the supporting portion 212 of the drainpipe 210 is hooked on and fixed to a top end of the holder 280, and the ink inside the developing unit 160 is withdrawn through the drainpipe 210 to the ink cartridge 150. Although not described or shown in the present embodiment, an additional sealing member may be installed in the drainpipe inlet 152 so as to prevent the ink inside the ink cartridge 150 from flowing out from the ink cartridge 150 when the coupling member 260 is inserted into the drainpipe inlet 152.

When the door 112 is opened to replace or inspect the ink cartridge 150, the drainpipe 210 ascends. Since a force of pulling down the wire 240 is removed, the drainpipe 210 ascends due to the elastic force of the elastic member 220, and the ink remaining in the developing unit 160 does not flow through the drainpipe 210 into the ink cartridge 150.

As described above, in a wet-type electrophotographic image forming apparatus according to the present invention, ink inside a developing unit is vertically withdrawn through a drainpipe to an ink cartridge without changing an ink flowing path or the area of the ink flowing path. Thus, the ink flowing path is substantially prevented from becoming clogged and the ink is substantially prevented from sticking to the ink flowing path. As a result, the ink is substantially prevented from overflowing in the developing unit.

Also, a pump is not used to withdraw the ink. Thus, the wet-type electrophotographic image forming apparatus has a simple structure, and thus the price of the wet-type electrophotographic image forming apparatus is lowered. Additionally, the developing unit, a fitting unit, and the ink cartridge may be coupled to one another by simply closing a door of an image forming apparatus body.

The foregoing embodiment and advantages are merely exemplary and are not to be construed as limiting the present invention. The present teaching may be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A wet-type image forming apparatus, comprising:
a body having an openable door;
a developing unit installed in the body and developing an image on a photosensitive body;
an ink cartridge detachably mounted with respect to the body to store ink; and
a fitting unit installed between the developing unit and the ink cartridge,the fitting unit moving up and down to couple and separate the developing unit and the ink cartridge.

2. The wet-type image forming apparatus of claim 1, wherein
the fitting unit moves in response to opening and closing of the door.

3. The wet-type image forming apparatus of claim 2, wherein
the fitting unit descends to thereby fluidly connect the developing unit and the ink cartridge when the door is closed, and the fitting unit ascends to thereby separate the developing unit from the ink cartridge when the door is opened.

4. The wet-type image forming apparatus of claim 3, wherein the fitting unit comprises:
a drainpipe forming an ink flowing path and ascends and descending in a substantially vertical direction to couple the developing unit to and separating the developing unit from the ink cartridge; and
a drainpipe transferring unit moving in association with the door to move the drainpipe.

5. The wet-type image forming apparatus of claim 4, wherein the drainpipe transferring unit comprises:
a coupling member moving substantially horizontally; and
a wire vertically moving the drainpipe in response to the horizontal movement of the coupling member.

6. The wet-type image forming apparatus of claim 5, wherein the ink cartridge comprising:
a drainpipe inlet into which the drainpipe is inserted; and
a transferring bar moving with the opening and closing of the door to horizontally move the coupling member.

7. The wet-type image forming apparatus of claim 5, wherein the drainpipe transferring unit further comprises:
an elastic member coupled to the drainpipe to elastically bias the drainpipe in one direction.

8. The wet-type image forming apparatus of claim 7, wherein the drainpipe transferring unit further comprises:
a holder comprising an elastic member housing hole housing the elastic member and fixed to the developing unit to support the drainpipe.

9. The wet-type image forming apparatus of claim 8, wherein the drainpipe transferring unit further comprises:
a flexible member comprising a first end fixed to the drainpipe and a second end fixed to the holder to prevent the ink inside the developing unit from flowing out from the drainpipe and into the drainpipe transferring unit.

10. The wet-type image forming apparatus of claim 5, wherein the drainpipe transferring unit further comprises:
a guide member guiding the horizontal movement of the coupling member.

11. The wet-type image forming apparatus of claim 5, wherein
the wire is metallic.

12. The wet-type image forming apparatus of claim 9, wherein
the flexible member is a flexible layer.

13. The wet-type image forming apparatus of claim 4, wherein
the drainpipe is substantially straight.

14. The wet-type image forming apparatus of claim 2, wherein
a drainpipe is movable between a withdrawn position in which the drainpipe is withdrawn from the ink cartridge when the door is open and an insertion position in which the drainpipe is inserted in the ink cartridge when the door is closed.

15. The wet-type image forming apparatus of claim 14, wherein
a drain inlet in the ink cartridge is opened to receive the drainpipe when the door is closed.

16. The wet-type image forming apparatus of claim 15, wherein
an elastic member connected to the drainpipe maintains the drainpipe in the withdrawn position.

17. The wet-type image forming apparatus of claim 16, wherein
a wire connected to the drainpipe is moved in response to closing of the door to move the drainpipe to the insertion position against the elastic member.

18. The wet-type image forming apparatus of claim 17, wherein
a flexible member connected to the drainpipe seals an aperture in the ink cartridge that receives the drainpipe.

19. A method of withdrawing ink from a ink cartridge of an image forming apparatus, comprising the steps of
mounting a drainpipe in the ink cartridge so that an inlet of the drainpipe is above the level of ink in the ink cartridge;
inserting an ink cartridge in a body of the image forming apparatus;
closing a door of the image forming apparatus to move a transferring bar connected to the ink cartridge;
moving the drainpipe in response to the door closing so that the drainpipe inlet is below the ink level and an outlet of the drainpipe is in the ink cartridge to drain ink from the developing cartridge to the ink cartridge.

20. The method of claim 19, further comprising
elastically biasing the drainpipe in the developing cartridge so that the inlet of the drainpipe returns to a position above the ink level when the door is opened.
